(19) United States
(12) Patent Application Publication
(10) Pub. No.: US 2002/0163632 A1
(43) Pub. Date: Nov. 7, 2002

(54) Measuring system of a gas stream environment

(76) Inventor: Ya-Chan Cheng, Hsin-Chu City (TW)

Correspondence Address: POWELL, GOLDSTEIN, FRAZER & MURPHY LLP, P.O. Box 97223, Washington, DC, 20090-7223, US

(21) Appl. No.: 09/847,111

(22) Filed: May 2, 2001

(51) Int. Cl. G01N 21/01

(52) U.S. Cl. 356/36

(57) ABSTRACT

This invention relates to a measuring system, more particularly, to a measuring system of a gas stream environment to measure the thickness of the wafer successfully and accurately. The gas stream environmental measuring system comprises a monitor, a stage, a lens, the first gas nozzle, a gas supplier, the second gas nozzle, a transport slot, a gas-extracting apparatus, a transport device, the first flow rate regulating valve, the second flow rate regulating valve, the first tube, the second tube, the third tube, a datum platen, and a datum slice. Using the gas stream, which is formed by using the gas exhausted from the first gas nozzle and the second gas nozzle to the wafer and the measuring reference point, makes the gas, which evaporates from the wafer, flow with the gas stream and flow to the outside of the measuring system by using the transport slot and the gas-extracting apparatus to measure the thickness of the wafer successfully and accurately.

### BACKGROUND OF THE INVENTION

1. Field of the Invention

This invention relates to a measuring system, more particularly, to a measuring system of a gas stream environment to measure the thickness of the wafer successfully and accurately. The present invention is used for measuring the thickness of the wafer. Using the gas stream, which is formed by using the first gas nozzle and the second gas nozzle, makes the gas, which evaporates from the wafer, flow with the gas stream and flow to the outside of the measuring system by using the transport slot and the gas-extracting apparatus to avoid the lens and the measuring reference point being polluted and to measure the thickness of the wafer successfully and accurately.

2. Description of the Prior Art

A semiconductor wafer which typically includes a silicon/silicon dioxide/silicon sandwich structure is fabricated by growing a silicon dioxide film on one surface of each of two silicon wafers and bonding the two silicon dioxide film surfaces together at high temperature. However, the earlier invention and the present invention can be used for measuring any number of layers providing only one layer thickness is unknown and the optical properties of all layers are accurately known.

The thickness of each layer in the wafer is the very important controlling parameter in the semiconductor process. The thickness of each layer will affect the characteristics of the semiconductor device, such as the electricity or the resistance degree. For example, if the thickness of the barrier layer is too thin, the barrier layer will lose its resistance ability when the current is connected with the semiconductor device to occur the leakage defect. The semiconductor device will lose its proper efficacy. Therefore, how to measure the thickness of each layer in the wafer is important.

The semiconductor wafer is produced by using many layers passing through a lot of deposition steps. In the deposition steps, the different kinds of gases will be used following the needs of the process, such as chlorine (Cl₂), boron chloride (BCl₃), and hydrogen bromide (HBr). The gases are easily to react with the atmosphere to form the solid phase by-products. If the solid phase by-products adhere to the surface of the apparatus, which is used to measure the thickness of the wafer, it will cause the over serious error in the measured result and will make the thickness of the material layer not conform to the needs of the design in the wafer. It will further affect the qualities of the semiconductor wafer.

Referring to FIG. 1 shows a traditional measuring system, which is used to measure the thickness of the material layers in the semiconductor wafer. Before the measuring system is operated, the measuring system must be adjusted to make the data, which is got after measuring, more accurate. At first, a piece of datum slice 15 is placed on the datum platen 10 in the measuring system to be the measuring reference point. The datum slice 15 is a section of the wafer whose thickness has known. Then the datum platen 10 is moved to the place under the lens 30 by using the transport device 27 to proceed the adjusting step for the lens 30. After adjusting the lens 30, the datum platen 10 is moved away from the place under the lens 30 and the stage 20 is moved to the inlet of the measuring system by using the transport device 27 at the same time to start the measuring process.

After the wafer 25 passing through the chemical mechanical polishing (CMP) process or the etching process, it will moved to the inlet of the measuring system by using the wafer cassette 60 and will be placed on the stage 27 by using a robot 65. Then, the stage 20 is moved to the place under the lens 30 by using the transport device 27 to start measuring the thickness of the wafer. The light is used to irradiate from the lens 30 to the surface of the wafer 25 and the data, which is returned from the light, is showed on the monitor 50. The thickness of the wafer will be known by analysing the data which is on the monitor 500.

Because the material of the wafer 25 is usually formed by using the vapor deposition ways, therefore, the volatility gas will be produced easily in the wafer 25. After passing through the chemical mechanical polishing process or the etching process, the volatility gas will be produced in the wafer 25 more easily. When the wafer 25 is placed on the stage 20 and the stage 20 is moved to the place under the lens by using the transport device 27 to start measuring the thickness of the wafer 25, the gas which evaporates from the inner wafer will adhere to the surface of the lens 30 and will form the solid phase by-products on the surface of the lens 30 to affect the measuring accurately. Therefore, the lens 30 must usually be cleaned to keep the accuracy of measuring the wafer 25 thickness. The lens is a precision measuring apparatus in the measuring system. If the cleaning process is not careful, the lens will be damaged to delay the efficiency of the process.

The gas which evaporates from the inner wafer will also move to the datum slice 15, which is on the measuring reference point, by a way in diffusion to cause the error in the lens adjusting process. If the lens adjusting process is not accurate, the thickness of the wafer, which is measured in the following measuring process, will cause serious error. This condition will cause the serious defects in the following process.

In the present technology, the volume of the semiconductor device is smaller and smaller and the thickness of the each material layer in the wafer is following thinner and thinner. When the traditional measuring system is used to measure the thickness of the wafer, the gas which evaporates from the inner wafer will pollute the lens to cause the errors in the measuring process easily and will pollute the datum slice to cause the errors in the adjusting process. This condition will affect the measuring accuracy of the real thickness after the measuring process by using the traditional measuring system. If the error is over serious, the serious defects will be caused in the following process to affect the qualities of the products and to increase the cost of the production.

### SUMMARY OF THE INVENTION

In accordance with the above-mentioned invention backgrounds, the traditional measuring system will make the gas which evaporates from the inner wafer pollute the lens and datum slice to affect the measuring accuracy of the real thickness and the qualities of the products, and to increase the cost of the production. The main objective of the invention is to prevent the gas which evaporates from the inner wafer polluting the lens by using the gas stream environmental measuring system.

The second objective of this invention is to prevent the gas which evaporates from the inner wafer polluting the datum slice by using the gas stream environmental measuring system.

The third objective of this invention is to increase the measuring accuracy of the real thickness by using the gas stream environmental measuring system.

The fourth objective of this invention is to increase the qualities of the products by using the gas stream environmental measuring system.

The fifth objective of this invention is to increase the efficiency of the process by using the gas stream environmental measuring system.

The further objective of this invention is to extend the using life of the lens and to decrease the cost of the production by using the gas stream environmental measuring system.

In according to the foregoing objectives, the present invention provides a gas stream environmental measuring system to use the gas stream, which is formed by using the exhausted gas from the first gas nozzle and the second gas nozzle to the wafer and the measuring reference point continuously, making the gas, which evaporates from the wafer, flow with the gas stream and flow to the outside of the measuring system by using the transport slot and the gas-extracting apparatus to measure the thickness of the wafer successfully and accurately. The flow rate of the gas, which exhausts from the first gas nozzle and the second gas nozzle, can be controlled by using the first flow rate regulating valve and the second flow rate regulating valve to avoid the pollution defects in the measuring system due to the flow rate of the gas stream over high or over low. The present invention can also increase the qualities of the products and to decrease the cost of the production. The present invention can further extend the using life of the lens and increase the efficiency of the process.

### BRIEF DESCRIPTION OF THE DRAWINGS

In the accompanying drawing forming a material part of this description, there is shown:

FIG. 1 shows a diagram in the traditional measuring system; and

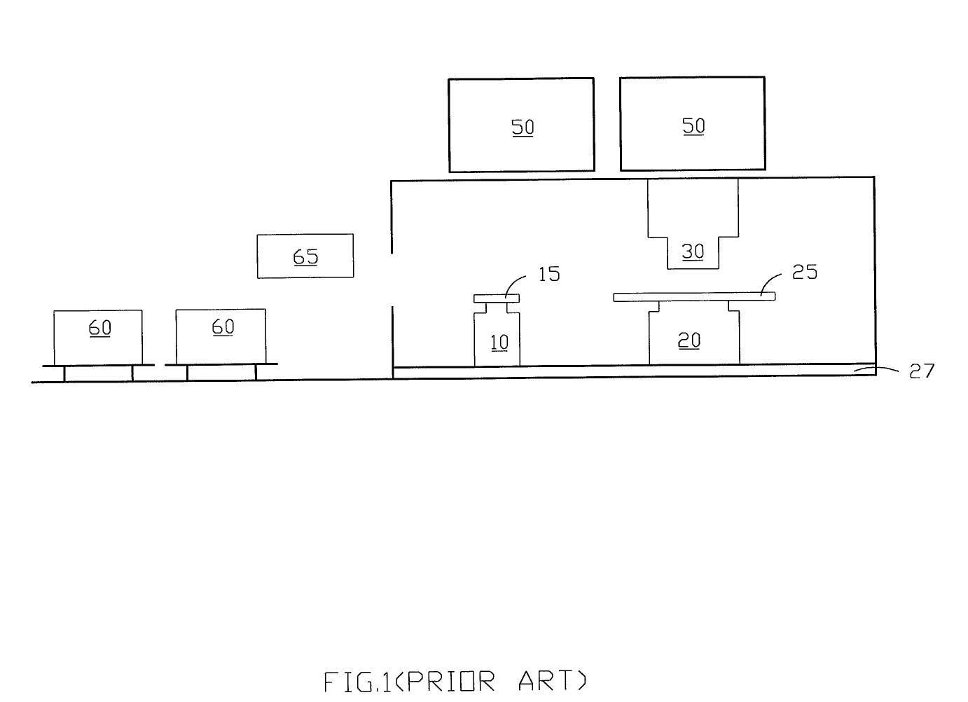

FIG. 2 shows a diagram in the present invention of the gas stream environmental measuring system.

### DESCRIPTION OF THE PREFERRED EMBODIMENT

The foregoing aspects and many of the attendant advantages of this invention will become more readily appreciated as the same becomes better understood by reference to the following detailed description, when taken in conjunction with the accompanying drawings, wherein:

In the semiconductor process, the thickness of the wafer is usually measured after the chemical mechanical polishing process or the etching process. In the chemical mechanical polishing process, the thickness of the polished material layer is controlled by the polishing time. But the surface quality, such as smooth of the surface, of the wafer will affect the quality of the following process after passing through the chemical mechanical polishing process. Therefore, the thickness of the wafer must be measured by using the measuring system to proceed the following process successfully. The amount of the etched material is also controlled by the etching time in the etching process. Therefore, the thickness of the wafer must be measured by using the measuring system after the etching process to avoid the higher error occurring in the thickness of the wafer to affect the quality of the products.

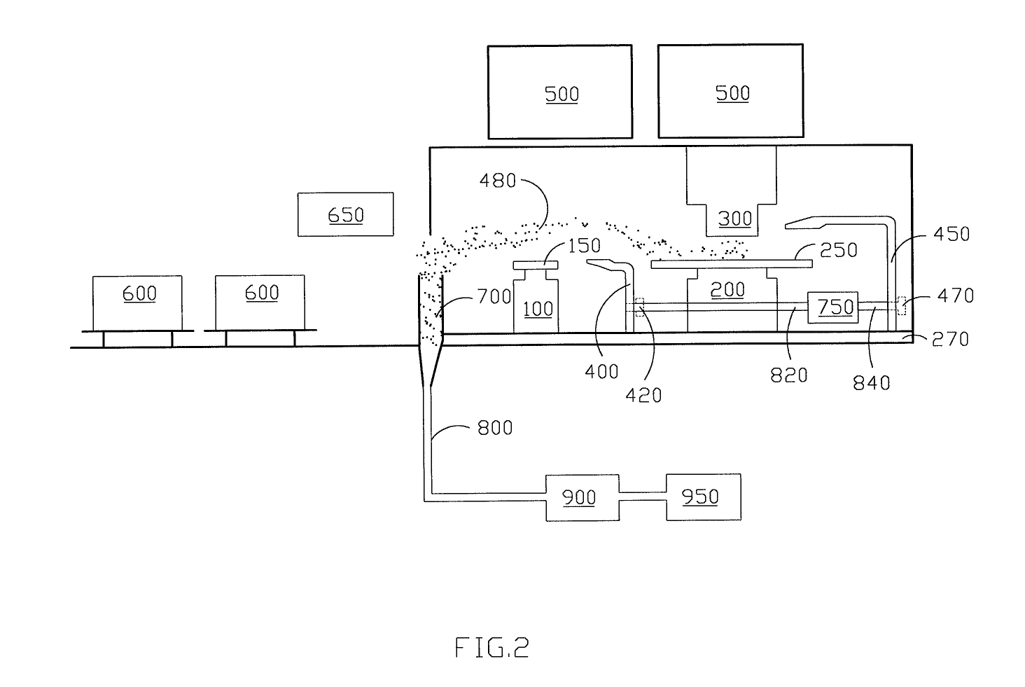

Referring to FIG. 2, this shows a diagram in the present invention of the gas stream environmental measuring system. The present invention of the gas stream environmental measuring system comprises a monitor 500, a stage 200, a lens 300, the first gas nozzle 400, a gas supplier 750, the second gas nozzle 450, a transport slot 700, an gas-extracting apparatus 900, a transport device 270, the first flow rate regulating valve 420, the second flow rate regulating valve 470, the first tube 820, the second tube 870, the third tube 800, a datum platen 100, and a datum slice 150. The first tube 820 is connected with the gas supplier 750 and the first gas nozzle 400. The second tube 870 is connected with the gas supplier 750 and the second gas nozzle 450. The third tube 800 is connected with the transport slot 700 and the gas-extracting apparatus 900. The first flow rate regulating valve 420 is on the first gas nozzle 400 and the second flow rate regulating valve 470 is on the second gas nozzle 450. The datum platen 100 and the stage 200 is on the transport device 270. The transport device 270 will make the datum platen 100 and the stage 200 move in the first axial direction and the second axial direction. The first gas nozzle 400 is located on a side of the datum platen 100 and the second gas nozzle 450 is located on a side of the stage 200.

Before the gas stream environmental measuring system begins to operate, the gas supplier must be opened at first to make the gas passing through the first tube 820 and the second tube 840 and exhausting from the first gas nozzle 400 and the second gas nozzle 450 to form a gas stream 480 in the measuring system. Then the gas extracting apparatus is opened to increase the flowing ability of the gas stream and decide the flowing direction of the gas stream 480. The gas stream 480 will pass through the transport slot 700 and the third tube 800 to the region, which is used to deal with the waste gas, by using the attraction, which is produced from the gas-attracting apparatus 900 to avoid the gas stream 480 moving to other regions by a way of diffusion in the measuring system. The gas-extracting apparatus 900 comprises a gas-extracting motor or a venturi structure. The gas which is used in the gas stream is an inert gas or nitrogen. The gas supplier 750 and the gas-extracting apparatus 900 must be opened continuously in the measuring process. The transport slot 700 is an opening of the measuring system. It is used to collect the gas stream 480 and used to be the channel to exhaust the gas stream 480.

Then a piece of datum slice 150 is placed on the datum platen 100 in the measuring system to be the measuring reference point. The datum slice 150 is a section of the wafer whose thickness has known. Then the datum platen 100 is moved to the place under the lens 300 by using the transport device 270 to proceed the adjusting step for the lens 300. After adjusting the lens 300, the datum platen 100 is moved away from the place under the lens 300 and the stage 200 is moved to the inlet of the measuring system by using the transport device 270 at the same time to start the measuring process.

After the wafer 250 passing through the chemical mechanical polishing process or the etching process, it will moved to the inlet of the measuring system by using the wafer cassette 600 and will be placed on the stage 270 by using a robot 650. Then, the stage 200 is moved to the place under the lens 300 by using the transport device 270 to start measuring the thickness of the wafer. The light is used to irradiate from the lens 300 to the surface of the wafer 250 and the data, which is returned from the light, is showed on the monitor 500. The thickness of the wafer will be known by analysing the data which is on the monitor 500.

Because the material of the wafer 250 is usually formed by using the vapor deposition ways, therefore, the volatility gas will be produced easily in the wafer 250. After passing through the chemical mechanical polishing process or the etching process, the volatility gas will be produced in the wafer 250 more easily. When the wafer 250 is placed on the stage 200 and the stage 200 is moved to the place under the lens 300 by using the transport device 270 to start measuring the thickness of the wafer 250, the gas which evaporates from the inner wafer 250 will be carried by the gas stream 480, which is exhausted from the second gas nozzle 450, and will make the gas not adhere to the surface of the lens 300 and not form the solid phase by-products on the surface of the lens 30 to increase the measuring accuracy. The gas stream 480, which is exhausted from the first gas nozzle, can avoid the gas, which evaporates from the inner wafer 250, not to deposit on the datum slice 150 by a way of diffusion to decrease the errors in the lens adjusting process. The gas, which evaporates from the inner wafer 250, will follow with the gas stream 480 passing through the transport slot 700 and the third tube 800 to the region, which is used to deal with the waste gas, by using the attraction, which is produced from the gas-attracting apparatus 900 to avoid the gas stream 480 moving to other regions by a way of diffusion in the measuring system and causing more serious pollution.

The lens is a precision measuring apparatus in the measuring system. If the present invention gas stream environment measuring system is used, the opportunity of the lens 300 pollution is decreased and the opportunity of cleaning the lens is also decreased. This condition will increase the efficiency of the process and can prevent the cost increasing due to the unsuitable cleaning lens process. In order to increase the measuring accuracy of the lens, the lens is usually fixed to prevent the measuring errors due to the shaking. But following the needs of the process, the lens can also fixed on a transport device to increase the efficiency of the measuring system.

In the present invention gas stream environmental measuring system, controlling the flow rate of the gas stream 480 is important. Therefore, the first flow rate regulating valve 420 is fixed on the first gas nozzle 400 and the second flow rate regulating valve 470 is fixed on the second gas nozzle 450 to control the flow rate of the gas stream 480. If the flow rate of the gas stream 480 is over high, the gas stream 480 will not flow in a fixed direction to the region 950, which is used to deal with the waste gas, by the attraction from the gas-attracting apparatus 900 and will spread by a way of diffusion in the measuring system to cause more serious pollution. If the flow rate of the gas stream 480 is over low, the gas, which evaporates from the inner wafer 250, will still adhere to the surface of the lens easily to cause the errors in the measuring results. Following the needs of the process, the flow rate regulating valve can also be fixed on the gas supplier or on the first tube 400 and the second tube 450 to control the flow rate of the gas stream 480, which exhausts from the first gas nozzle 400 and the second gas nozzle 450.

In the present gas-stream environmental measuring system, the objective of the second gas nozzle 450 is to avoid the lens 300 being polluted by the gas, which evaporates from the inner wafer 250. The objective of the first gas nozzle 400 is to avoid the datum slice 150 being polluted by the gas, which evaporates from the inner wafer 250. Therefore, the second gas nozzle 400 can not exhaust the gas stream 480 to the lens 300 to avoid the gas, which evaporates from the inner wafer 250, following the gas stream 480 to pollute the lens 300. The first gas nozzle 400 and the second gas nozzle 450 are decided to be fixed on the transport apparatus and are following the movement of the first gas nozzle 400 and the second gas nozzle 450 or not following the needs of the process to bring the gas stream 480 into full play and to increase the efficiency of the process.

In accordance with the present invention, the present invention provides a gas stream environmental measuring system to use the gas stream, which is formed by using the exhausted gas from the first gas nozzle and the second gas nozzle to the wafer and the measuring reference point continuously, making the gas, which evaporates from the wafer, flow with the gas stream and flow to the outside of the measuring system by using the transport slot and the gas-extracting apparatus to measure the thickness of the wafer successfully and accurately. The flow rate of the gas, which exhausts from the first gas nozzle and the second gas nozzle, can be controlled by using the first flow rate regulating valve and the second flow rate regulating valve to avoid the pollution defects in the measuring system due to the flow rate of the gas stream over high or over low. The present invention can also increase the qualities of the products and to decrease the cost of the production. The present invention can further extend the using life of the lens and increase the efficiency of the process.

Although specific embodiments have been illustrated and described, it will be obvious to those skilled in the art that various modifications may be made without departing from what is intended to be limited solely by the appended claims.

What is claimed is:

1. a measuring system of a gas-stream environment, said measuring system comprises:
a stage, wherein said stage is located on a transport apparatus and used to place a wafer;
a datum platen, wherein said datum platen is located on said transport apparatus and on a side of said stage to be used to place a datum slice;
a lens, wherein said lens is located above said stage to measure said wafer and said datum slice;
a gas supplier, wherein said gas supplier is used to supply a gas;
a first gas nozzle, wherein said first gas nozzle is located on a side of said datum platen and is used to exhaust said gas;
a second gas nozzle, wherein said second gas nozzle is located on a side of said stage and is used to exhaust said gas;
a first tube, wherein said first tube is connected with said first gas nozzle and said gas supplier;
a second tube, wherein said second tube is connected with said second gas nozzle and said gas supplier;
a transport slot, wherein said transport slot is an opening to exhaust said gas; and
a gas-extracting apparatus, wherein said gas-extracting apparatus connects with said transport slot by using a third tube and is used to produce a attraction to remove said gas.

2. The system according to claim 1, wherein said first tube comprises a flow rate regulating valve.

3. The system according to claim 1, wherein said second tube comprises a flow rate regulating valve.

4. The system according to claim 1, wherein said gas-extracting apparatus comprises a gas-extracting motor.

5. The system according to claim 1, wherein said gas-extracting apparatus comprises a venturi structure.

6. The system according to claim 1, wherein said gas is a inert gas.

7. The system according to claim 1, wherein said gas is a nitrogen.

8. The system according to claim 1, wherein said gas supplier comprises a flow rate regulating valve.

9. a measuring system of a gas-stream environment, said measuring system comprises:
a stage, wherein said stage is located on a transport apparatus and used to place a wafer;
a datum platen, wherein said datum platen is located on said transport apparatus and on a side of said stage to be used to place a datum slice;
a lens, wherein said lens is located above said stage to measure said wafer and said datum slice;
a gas supplier, wherein said gas supplier is used to supply a gas;
a first gas nozzle, wherein said first gas nozzle is located on a side of said datum platen to exhaust said gas and comprises a first flow rate regulating valve;
a second gas nozzle, wherein said second gas nozzle is located on a side of said stage to exhaust said gas and comprises a first flow rate regulating valve;
a first tube, wherein said first tube is connected with said first gas nozzle and said gas supplier;
a second tube, wherein said second tube is connected with said second gas nozzle and said gas supplier;
a transport slot, wherein said transport slot is an opening to exhaust said gas; and
a gas-extracting apparatus, wherein said gas-extracting apparatus connects with said transport slot by using a third tube and is used to produce a attraction to remove said gas.

10. The system according to claim 9, wherein said first tube comprises a flow rate regulating valve.

11. The system according to claim 9, wherein said second tube comprises a flow rate regulating valve.

12. The system according to claim 9, wherein said gas-extracting apparatus comprises a gas-extracting motor.

13. The system according to claim 9, wherein said gas-extracting apparatus comprises a venturi structure.

14. The system according to claim 9, wherein said gas is a inert gas.

15. The system according to claim 9, wherein said gas is a nitrogen.

16. The system according to claim 9, wherein said gas supplier comprises a flow rate regulating valve.

17. a measuring system of a gas-stream environment, said measuring system comprises:
a stage, wherein said stage is located on a transport apparatus and used to place a wafer;
a datum platen, wherein said datum platen is located on said transport apparatus and on a side of said stage to be used to place a datum slice;
a lens, wherein said lens is located above said stage to measure said wafer and said datum slice;
a gas supplier, wherein said gas supplier is used to supply a gas;
a first gas nozzle, wherein said first gas nozzle is located on a side of said datum platen and on said transport apparatus to exhaust said gas;
a second gas nozzle, wherein said second gas nozzle is located on a side of said stage and on said transport apparatus to exhaust said gas;
a first tube, wherein said first tube comprises a first flow rate regulating valve and is connected with said first gas nozzle and said gas supplier;
a second tube, wherein said second tube comprises a second flow rate regulating valve and is connected with said second gas nozzle and said gas supplier;
a transport slot, wherein said transport slot is an opening to exhaust said gas; and
a gas-extracting apparatus, wherein said gas-extracting apparatus connects with said transport slot by using a third tube and is used to produce a attraction to remove said gas.

18. The system according to claim 17, wherein said gas-extracting apparatus comprises a venturi structure.

19. The system according to claim 17, wherein said gas is a inert gas.

20. The system according to claim 17, wherein said gas is a nitrogen.
